(19) United States
(12) Patent Application Publication
(10) Pub. No.: US 2007/0007875 A1
(43) Pub. Date: Jan. 11, 2007

(54) FLAT PANEL SPACER BASE MATERIAL, METHOD OF MANUFACTURING FLAT PANEL DISPLAY SPACER BASE MATERIAL, FLAT PANEL DISPLAY SPACER, AND FLAT PANEL DISPLAY

(75) Inventors: Yukio Kawaguchi, Tokyo (JP); Atsushi Hitomi, Tokyo (JP); Kazumitsu Tanaka, Tokyo (JP); Takao Matsumoto, Tokyo (JP); Masahiro Itoh, Tokyo (JP); Kenichi Jinguji, Tokyo (JP); Tsutomu Koyanagi, Tokyo (JP)

Correspondence Address: OLIFF & BERRIDGE, PLC, P.O. BOX 19928, ALEXANDRIA, VA, 22320, US

(73) Assignee: TDK Corporation, Tokyo (JP)

(21) Appl. No.: 10/557,801

(22) PCT Filed: May 21, 2004
(86) PCT No.: PCT/JP04/07336

§ 371 Date: Apr. 17, 2006

(30) Foreign Application Priority Data
May 23, 2003 (JP) 2003-146798

(51) Int. Cl. H01J 29/82

(52) U.S. Cl. 313/482; 313/292

(57) ABSTRACT

A sintered body containing Al₂O₃, TiC, and TiO₂ such that 6.5 to 10 wt % of TiC and 1.0 to 2.5 wt % of TiO₂ exist with respect to the total weight of Al₂O₃, TiC, and TiO₂ is employed as a flat panel display spacer base material.

### TECHNICAL FIELD

The present invention relates to a flat panel display spacer base material, a method of manufacturing a flat panel display spacer base material, a flat panel display spacer, and a flat panel display.

### BACKGROUND ART

Field emission displays (FEDs) have been known as self-emission type flat panel displays employing a conventional cathode-ray tube (CRT). An FED comprises a cathode structure in which a number of cathodes (field emission devices) are arranged two-dimensionally, whereas electrons emitted from the cathodes in an environment at a reduced pressure are caused to impinge on individual fluorescent pixel areas, so as to form emission images. Each fluorescent pixel area includes a phosphorus layer.

The above-mentioned flat panel displays are equipped with a backplate including the cathode structure. U.S. Pat. No. 5,541,473 discloses an example of such flat panel displays. The backplate of this display is formed by depositing the cathode structure onto a glass sheet.

This flat panel display comprises a glass faceplate on which a phosphorus layer is deposited. A conductive layer for applying an electric field is deposited on the glass or phosphorus layer.

The faceplate is separated from the backplate by 0.1 mm to 1 mm or 2 mm. Strip-like spacers each made of a wall are vertically interposed between the faceplate and the backplate. While it is desirable that the spacers be arranged at accurate positions, the atmospheric pressure exerts a heavy load on the spacers when the display is vacuumed.

This load is said to reach 1 ton in a 10-inch display. When the spacers become misaligned or tilted by the load, the emitted electrons deflect, thereby causing visible defects on the display. It is necessary for the spacers to endure a quite heavy compressive force between the faceplate and the backplate, have the same height among the spacers, and be flat. The spacers must have a coefficient of thermal expansion close to that of a glass plate as a faceplate and be less dependent on temperature.

Since a high voltage of 1 kV or more, for example, is applied between the faceplate and the backplate, a tolerance to the high voltage and a secondary radiation characteristic are required for the spacers. Known as conventional spacers are those in which an insulating material made of alumina is coated with a conductive material (see, for example, Japanese Translated International Application Laid-Open Nos. 2002-508110 and 2001-508926), those having an irregular film formed by fine particles of oxides and the like (see, for example, Japanese Patent Application Laid-Open No. 2001-68042), those made of ceramics in which transition metal oxides are dispersed (see, for example, Japanese Translated International Application Laid-Open Nos. HEI 11-500856 and 2002-515133), etc.

### DISCLOSURE OF THE INVENTION

However, there have been cases where image distortions and the like occur when the conventional spacers are used. In view of such a problem, it is an object of the present invention to provide a flat panel display spacer base material, a method of manufacturing the same, a flat panel display spacer, and a flat panel display which can reduce the occurrence of image distortions and the like.

The inventor conducted diligent studies and, as a result, has found that a sintered body containing Al₂O₃, TiC, and TiO₂ at a predetermined ratio is suitable as a spacer base material, thereby conceiving the present invention.

The flat panel display spacer base material in accordance with the present invention includes a sintered body containing Al₂O₃, TiC, and TiO₂ such that 6.5 to 10 wt % of TiC and 1.0 to 2.5 wt % of TiO₂ exist with respect to the total weight of Al₂O₃, TiC, and TiO₂.

The method of manufacturing a flat panel display spacer material in accordance with the present invention comprises the steps of mixing powders of Al₂O₃, TiC, and TiO₂ such that 6.5 to 10 wt % of the TiC powder and 1.0 to 2.5 wt % of the TiO₂ powder exist with respect to the total weight of the Al₂O₃, TiC, and TiO₂ powders; and firing thus obtained mixture so as to yield a sintered body.

The flat panel display spacer in accordance with the present invention is formed from a sintered body containing Al₂O₃, TiC, and TiO₂ such that 6.5 to 10 wt % of TiC and 1.0 to 2.5 wt % of TiO₂ exist with respect to the total weight of Al₂O₃, TiC, and TiO₂, and is interposed between a backplate including a cathode structure and a faceplate including a fluorescent pixel area.

The flat panel display in accordance with the present invention comprises a backplate including a cathode structure; a faceplate including a fluorescent pixel area; and a flat panel display spacer interposed between the backplate and the faceplate and formed from a sintered body containing Al₂O₃, TiC, and TiO₂ such that 6.5 to 10 wt % of TiC and 1.0 to 2.5 wt % of TiO₂ exist with respect to the total weight of Al₂O₃, TiC, and TiO₂.

In these aspects of the present invention, the sintered body is a composite ceramic containing TiC and Al₂O₃. Such a composite ceramic exhibits properties of AlTiC which is a conductive ceramic having a high hardness and can endure deformations due to compressive forces. Therefore, image distortions and the like can be reduced when a spacer base material made of such a sintered body is used as a flat panel display spacer.

The sintered body contains 6.5 to 10 wt % of TiC and 1.0 to 2.5 wt % of TiO₂ with respect to the total weight of Al₂O₃, TiC, and TiO₂. When the resistivity value of such a sintered body is measured while the electric field applied thereto is changed within the range of about 0 to 10000 V/mm, the resistivity value decreases gradually as the electric field increases, and the resistivity value does not decrease drastically when the electric field exceeds a certain level within this range. A sintered body having a resistivity value of about 1.0×10⁶ Ω.cm to 1.0×10¹¹ Ω.cm can easily be obtained when compositions of TiC and TiO₂ are changed within their ranges mentioned above. Therefore, when a spacer base material having such a sintered body is used for a flat panel display spacer, the latter exhibits a desirable conductivity even upon electric field application, and is harder to be charged electrically, while thermal runaway due to an overcurrent flow is suppressed, whereby image distortions and the like in the flat panel display can further be reduced.

### BRIEF DESCRIPTION OF THE DRAWINGS

FIG. 1 is a chart showing compositions and characteristics of spacer materials in accordance with Examples 1-1 to 1-4 and Comparative Examples 1-1 and 1-2;

FIG. 2 is a chart showing compositions and characteristics of spacer materials in accordance with Examples 2-1 to 2-4 and Comparative Examples 2-1 and 2-2;

FIG. 3 is a chart showing compositions and characteristics of spacer materials in accordance with Examples 3-1 to 3-4 and Comparative Examples 3-1 and 3-2;

FIG. 4 is a chart showing compositions and characteristics of spacer materials in accordance with Examples 4-1 to 4-4 and Comparative Examples 4-1 and 4-2;

FIG. 5 is a chart showing compositions and characteristics of spacer materials in accordance with Comparative Examples 5-1 to 5-5;

FIG. 6 is a chart showing compositions and characteristics of spacer materials in accordance with Comparative Examples 6-1 to 6-5;

FIG. 7 is a graph showing relationships between the resistivity and applied voltage in the spacer base materials in Examples 2-1 to 2-4 and Comparative Examples 2-1 and 2-2;

FIG. 8 is a graph showing relationships between the added amount of TiC and the resistivity value of spacer base materials at an applied electric field of 10000 V/mm;

FIG. 9 is a plan view of a flat panel display;

FIG. 10 is a sectional view of the flat panel display taken along the line X-X;

FIG. 11 is a plan view showing the inner structure of the flat panel display on the faceplate side; and

FIGS. 12A to 12G are explanatory views for explaining a method of manufacturing a spacer.

### BEST MODES FOR CARRYING OUT THE INVENTION

In the following, preferred embodiments of the present invention will be explained in detail with reference to the accompanying drawings. In the explanation of the drawings, constituents identical or equivalent to each other will be referred to with numerals identical to each other without repeating their overlapping descriptions.

First, the flat panel display spacer base material in accordance with an embodiment and a method of manufacturing the same will be explained. Employed as a flat panel display spacer base material in this embodiment is a composite ceramic sintered body containing Al₂O₃ (alumina), TiC (titanium carbide), and TiO₂ (titania) such that 6.5 to 10 wt % of TiC and 1.0 to 2.5 wt % of TiO₂ exist with respect to the total weight of Al₂O₃, TiC, and TiO₂.

Such a spacer base material is obtained by mixing powders of Al₂O₃, TiC, and TiO₂ such that 6.5 to 10 wt % of the TiC powder and 1.0 to 2.5 wt % of the TiO₂ powder exist with respect to the total weight of Al₂O₃, TiC, and TiO₂ powders; shaping the obtained mixture; firing the shaped body; and cooling the fired body.

The method of manufacturing the spacer base material in accordance with this embodiment will now be explained in detail. First, powders of Al₂O₃, TiC, and TiO₂ to become raw materials are prepared. Preferably, the Al₂O₃ powder in the raw materials is a fine powder and has an average particle size of 0.1 to 1 μm, 0.4 to 0.6 μm in particular. Preferably, the TiC powder is a fine powder and has an average particle size of 0.1 to 3 μm, 0.5 to 1.5 μm in particular. Preferably, the TiO₂ powder is a fine powder and has an average particle size of 0.1 to 3 μm, 0.5 to 1 μm in particular.

These powders are mixed such that 6.5 to 10 wt % of the TiC powder and 1.0 to 2.5 wt % of the TiO₂ powder are contained with respect to the total weight of Al₂O₃, TiC, and TiO₂ powders.

Preferably, the powders are mixed in a ball mill or attritor. For favorable mixing, a solvent other than water, such as ethanol, IPA, or 95% denatured ethanol, for example, is used. Preferably, they are mixed for about 10 to 100 hours. As mixing media in the ball mill or attritor, alumina balls and zirconia balls having a diameter on the order of 1 to 20 mm, for example, are preferably used.

Subsequently, thus mixed powders are granulated by spraying. Here, it will be sufficient if the mixed powders are spray-dried in a hot wind of an inert gas such as nitrogen or argon substantially free of oxygen at a temperature on the order of 60 to 200° C., whereby a granulated product of the mixed powders in the above-mentioned composition is obtained. The particle size of the granulated product is preferably on the order of 50 μm to 200 μm, for example.

Then, the liquid content of the granulated product is adjusted with a solvent or the like added as necessary, so that the solvent is contained in the granulated product by about 0.1 to 10 wt %.

Next, a mold is filled with the granulated product, and is subjected to primary molding by cold press, so as to yield a molded body. Here, for example, a mold made of a metal or carbon having an inner diameter of 150 mm for forming a disk is filled with the granulated product and is cold-pressed at a pressure on the order of 5 to 15 MPa (50 to 150 kgf/cm²).

Subsequently, the primarily molded article is hot-pressed, so as to yield a sintered body. Preferably, the sintering temperature is 1200 to 1700° C., the pressure is 10 to 50 MPa (100 to 500 MPa), and the atmosphere is vacuum, nitrogen, or argon, for example. Here, the nonoxidizing atmosphere is employed in order to prevent TiC from being oxidized. Preferably, a mold made of carbon is used. The sintering time is preferably on the order of 1 to 3 hours.

After inspecting the exterior and the like, mechanical finishing is effected by diamond whetstone or the like, so as to complete a flat panel display spacer base material. An example of specific forms of the final flat panel display spacer substrate is a disk-shaped substrate having a diameter of 6 inches and a thickness of about 2 mm.

The resulting spacer base material is a composite ceramic sintered body containing TiC and Al₂O₃, and thus exhibits properties of AlTiC, which is a conductive ceramic having a high hardness, and can endure deformations due to compressive forces. Therefore, when this spacer base material is used for a spacer of a flat panel display, the spacer is less likely to become misaligned or tilted, whereby image distortions can be reduced.

The spacer base material is a sintered body containing 6.5 to 10 wt % of TiC and 1.0 to 2.5 wt % of TiO₂ with respect to the total weight of Al₂O₃, TiC, and TiO₂. When the resistivity value of such a sintered body is measured while the electric field applied thereto is changed within the range of about 0 to 10000 V/mm, the resistivity value decreases gradually as the electric field increases, and the resistivity value does not decrease drastically when the electric field exceeds a certain level within this range. A sintered body having a resistivity value of about 1.0×10⁶ Ω.cm to 1.0×10¹¹ Ω.cm can easily be obtained when compositions of TiC and TiO₂ are changed within their ranges mentioned above.

Therefore, when such a spacer base material is used as a spacer for a flat panel display, the spacer exhibits a desirable conductivity even upon electric field application, and is harder to be charged electrically. This suppresses not only the deflection of electron orbits due to electric charges, but also the thermal runaway caused by an overcurrent flow, whereby image distortions and the like in the flat panel display can further be reduced.

When the TiC content is less than 6.5 wt % or more than 10 wt %, the resistivity value drastically decreases before the electric field reaches 10000 V/mm. When the TiO₂ content is less than 1.0 wt % or more than 2.5 wt %, the resistivity value of the spacer base material is hard to fall within the range of 1.0×10⁶ Ω.cm to 1.0×10¹¹ .cm, which is considered to be a favorable range for the resistivity value of the spacer. When the resistivity value is higher than this range, for example, electric charges are likely to occur, so that distortions and the like may be generated. When the resistivity value is lower than this range, an overcurrent may occur, thereby causing thermal runaway.

In the composition range of the sintered body in accordance with this embodiment, the change in the resistivity value of the sintered body in the case where the composition of TiC or TiO₂ varies is relatively small, for example. Therefore, a spacer base material having a resistivity value on the order of 1.0×10⁶ Ω.cm to 1.0×10¹¹ Ω.cm can easily be manufactured with a high yield while reducing fluctuations in the resistivity value.

Examples of the spacer base material in accordance with this embodiment will now be explained.

### EXAMPLES 1-1 TO 1-4

First, respective predetermined amounts of an Al₂O₃ powder (with an average particle size of 0.5 μm and a purity of 99.9%), a TiC powder (with an average particle size of 0.5 μm, a purity of 99%, and a carbon content of at least 19% in which free graphite was 1% or less), and a TiO₂ powder were weighed, pulverized and mixed with ethanol in a ball mill for 30 minutes, and granulated by spraying in nitrogen at 150° C., so as to yield a granulated product. In each of Examples 1-1 to 1-4, the content of TiO₂ powder was 1.0 wt % with respect to the total weight of Al₂O₃, TiC, and TiO₂ powders. The content of TiC powder with respect to the total weight was 10.0 wt % in Example 1-1, 8.0 wt % in Example 1-2, 7.0 wt % in Example 1-3, and 6.5 wt % in Example 1-4.

Subsequently, each of these mixtures was primarily molded at about 0.5 MPa (50 kgf/cm²), and was fired by hot press in a vacuum atmosphere at a sintering temperature of 1600° C. and a press pressure of about 30 MPa (about 300 kgf/cm²) for 1 hour, so as to yield a spacer base material for each example.

### COMPARATIVE EXAMPLES 1-1 AND 1-2

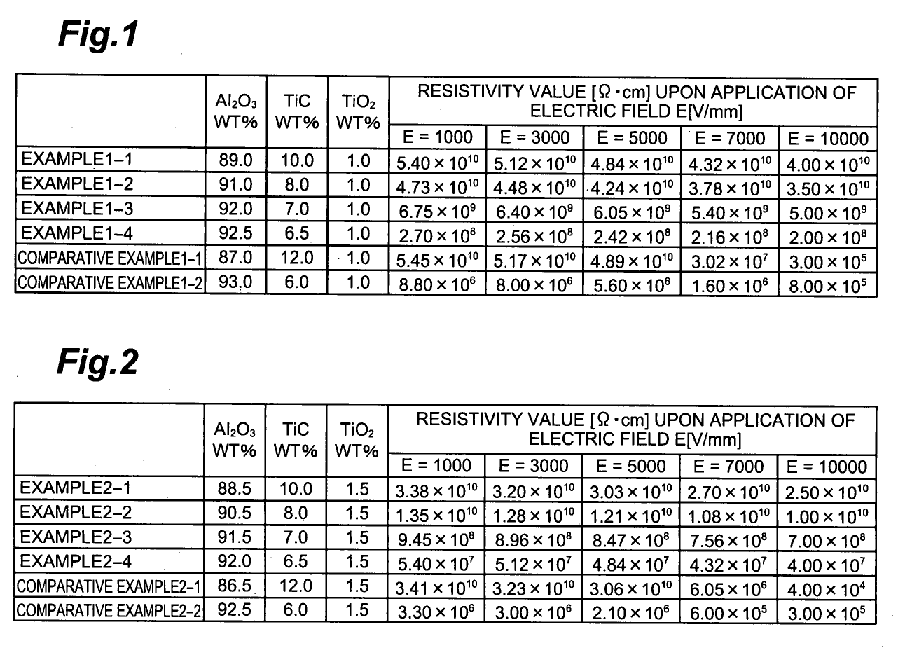

The spacers of Comparative Examples 1-1 and 1-2 were obtained as with Example 1-1 except that the TiC content was 12.0 wt % and 6.0 wt %, respectively, while the TiO₂ content with respect to the total weight was 1.0 wt % in each of them as in Example 1-1. The table of FIG. 1 shows respective compositions of ingredients in Examples 1-1 to 1-4 and Comparative Examples 1-1 and 1-2.

### EXAMPLES 2-1 TO 2-4

The spacer base materials of Examples 2-1 to 2-4 were obtained as with Example 1-1 except that the TiC content was 10.0 wt %, 8.0 wt %, 7.0 wt %, and 6.5 wt % successively from Example 2-1 as in Examples 1-1 to 1-4, while the TiO₂ content was 1.5% in each of them.

### COMPARATIVE EXAMPLES 2-1 AND 2-2

The spacer base materials of Comparative Examples 2-1 and 2-2 were obtained as with Example 2-1 except that the mixing was effected with the TiC contents of 12.0 wt % and 6.0 wt %, respectively, while the TiO₂ content was 1.5 wt % in each of them as in Example 2-1. The table of FIG. 2 shows respective compositions of ingredients in Examples 2-1 to 2-4 and Comparative Examples 2-1 and 2-2.

### EXAMPLES 3-1 TO 3-4

The spacer base materials of Examples 3-1 to 3-4 were obtained as with Example 1-1 except that the TiC content was 10.0 wt %, 8.0 wt %, 7.0 wt %, and 6.5 wt % successively from Example 3-1 as in Examples 1-1 to 1-4, while the TiO₂ content was 2.0 wt % in each of them.

### COMPARATIVE EXAMPLES 3-1 AND 3-2

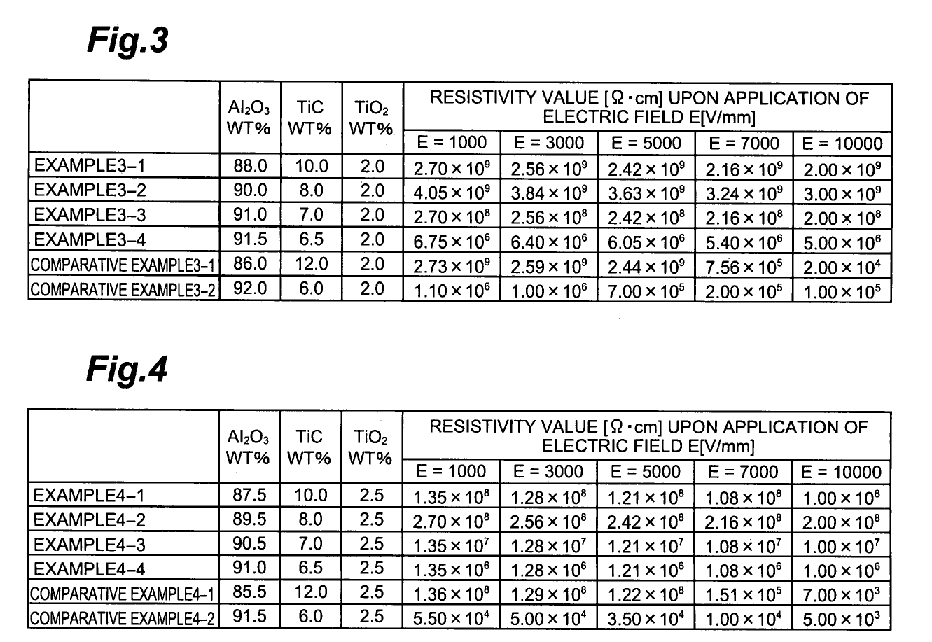

The spacer base materials of Comparative Examples 3-1 and 3-2 were obtained as with Example 3-1 except that the mixing was effected with the TiC contents of 12.0 wt % and 6.0 wt %, respectively, while the TiO₂ content was 2.0 wt % in each of them as in Example 3-1. The table of FIG. 3 shows respective compositions of ingredients in Examples 3-1 to 34 and Comparative Examples 3-1 and 3-2.

### EXAMPLES 4-1 TO 4-4

The spacer base materials of Examples 4-1 to 4-4 were obtained as with Example 1-1 except that the TiC content was 10.0 wt %, 8.0 wt %, 7.0 wt %, and 6.5 wt % successively from Example 4-1 as in Examples 1-1 to 1-4, while the TiO₂ content was 2.5 wt % in each of them.

### COMPARATIVE EXAMPLES 4-1 AND 4-2

The spacer base materials of Comparative Examples 4-1 and 4-2 were obtained as with Example 4-1 except that the mixing was effected with the TiC contents of 12.0 wt % and 6.0 wt %, respectively, while the TiO₂ content was 2.5 wt % in each of them as in Example 4-1. The table of FIG. 4 shows respective compositions of ingredients in Examples 4-1 to 4-4 and Comparative Examples 4-1 and 4-2.

### COMPARATIVE EXAMPLES 5-1 TO 5-5

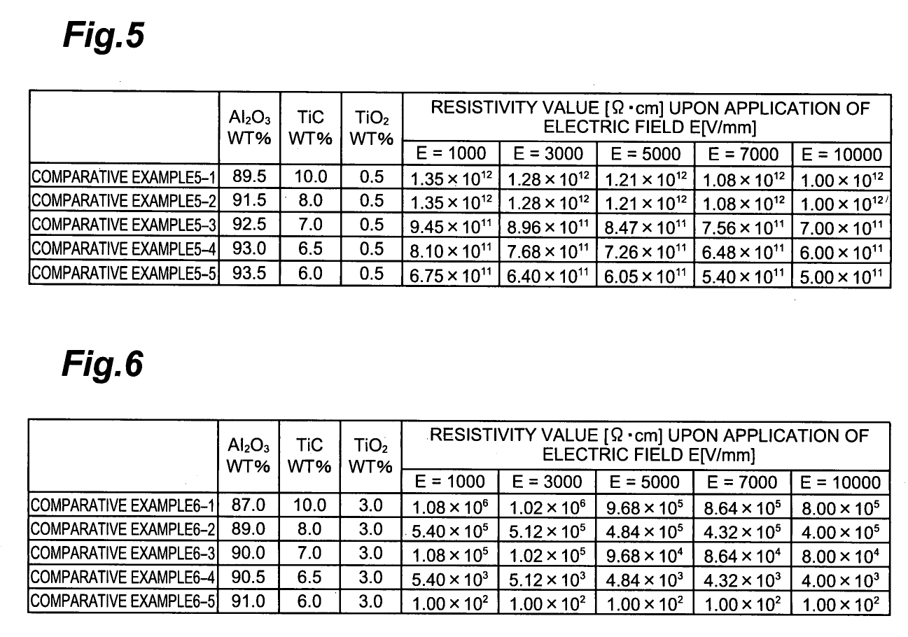

The spacer base materials of Comparative Examples 5-1 to 5-5 were obtained as with Example 1-1 except that the TiC content was 10.0 wt %, 8.0 wt %, 7.0 wt %, 6.5 wt %, and 6.0 wt % successively from Comparative Example 5-1, while the TiO₂ content was 0.5 wt % in each of them. The table of FIG. 5 shows respective compositions of ingredients in Comparative Examples 5-1 to 5-5.

### COMPARATIVE EXAMPLES 6-1 TO 6-5

The spacer base materials of Comparative Examples 6-1 to 6-5 were obtained as with Example 1-1 except that the TiC content was 12.0 wt %, 10.0 wt %, 8.0 wt %, 7.0 wt %, 6.5 wt %, and 6.0 wt % successively from Comparative Example 6-1, while the TiO₂ content was 3.0 wt % in each of them. The table of FIG. 6 shows respective compositions of ingredients in Comparative Examples 6-1 to 6-5.

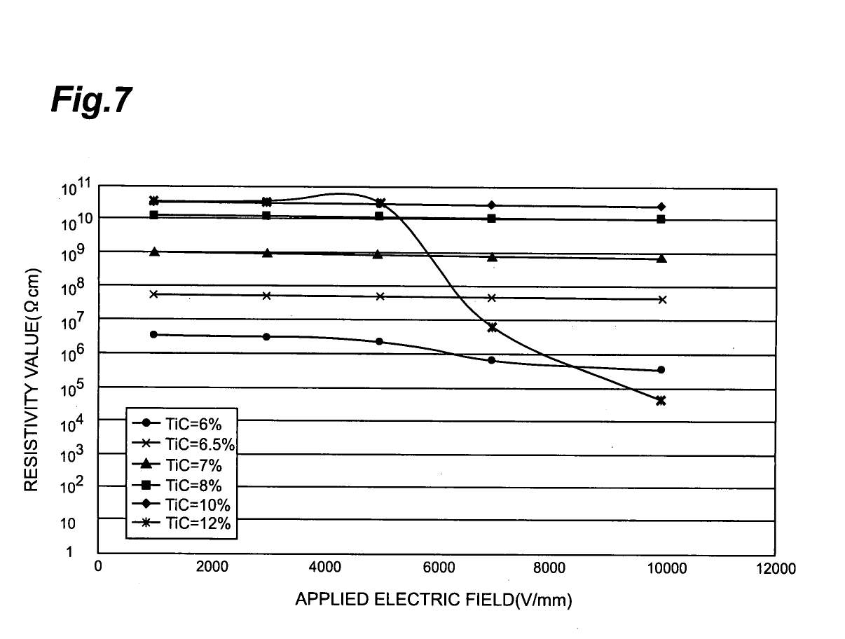

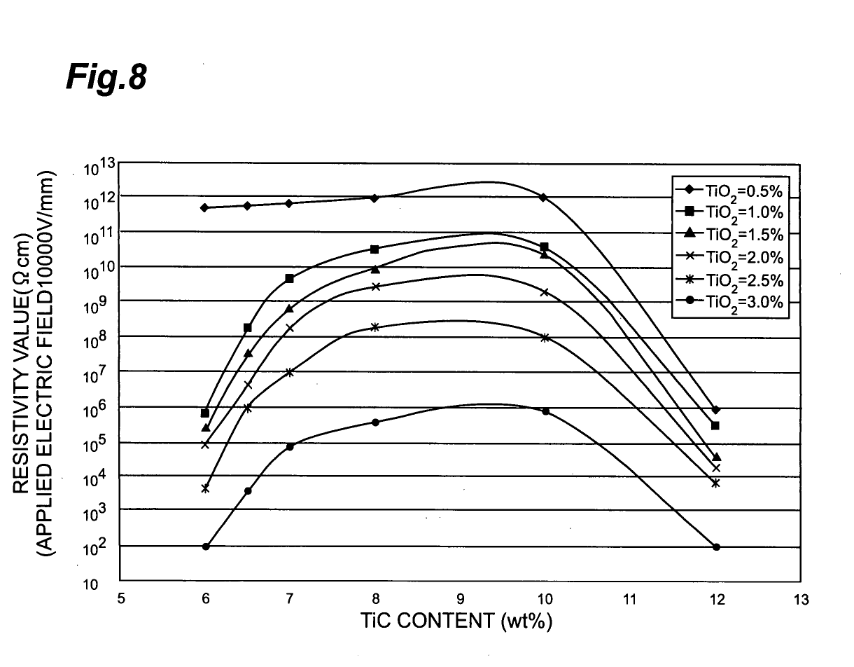

The tables of FIGS. 1 to 6 show resistivity values of thus obtained spacer base materials measured when various electric fields are applied thereto. FIG. 7 shows relationships between the resistivity and applied electric field in the spacer base materials containing 1.5 wt % of TiO₂ (Examples 2-1 to 2-4 and Comparative Examples 2-1 and 2-2). FIG. 8 shows relationships between the contents of TiC and TiO₂ and the resistivity value of spacer base materials when an electric field of 10000 V/mm is applied thereto.

As can be seen from FIG. 7, the resistivity value decreases drastically when the magnitude of electric field exceeds a predetermined value within the electric field range of 0 to 10000 V/mm in the case where the TiC content is 6 wt % or less (Comparative Example 2-1) or more than 12 wt % (Comparative Example 2-2), and not drastically but gradually decreases within the electric field range of 0 to 10000 V/mm in the case where the TiC content is at least 6.5 wt % but not greater than 10 wt % (Examples 2-1 to 2-4).

The same holds in the cases where the TiO₂ content is 1.0% (Examples 1-1 to 1-4 and Comparative Examples 1-1 and 1-2), 2.0% (Examples 3-1 to 3-4 and Comparative Examples 3-1 and 3-2), 2.5% (Examples 4-1 to 4-4 and Comparative Examples 4-1 and 4-2), and the like as can be understood from the tables of FIGS. 1 to 6.

On the other hand, as can be seen from FIG. 8, it is difficult for the resistivity value of a spacer base material to fall within the range of 1.0×10⁶ Ω.cm to 1.0×10¹¹ Ω.cm, which is a preferred resistivity value range for a flat panel display spacer, when the TiC content is at least 6.5 wt % but not greater than 10 wt % in the case where the TiO₂ content is 0.5 wt % or less as in Comparative Examples 5-1 to 5-5 or about 3.0 wt % or more as in Comparative Examples 6-1 to 6-5.

When the compositions of TiC and TiO₂ are regulated while the TiO₂ content is at least 1.0 wt % but not greater than 2.5 wt % as in Examples 1-1 to 1-4, 2-1 to 2-4, 3-1 to 3-4, and 4-1 to 4-4, by contrast, the resistivity value of a spacer base material can fall within the range of 1.0×10⁶ Ω.cm to 1.0×10¹¹ Ω.cm, which is a preferred resistivity range for a flat panel display spacer.

The spacer base materials of the above-mentioned examples were seen to have a density of 3.9 to 4.2 g/cm², Vickers hardness of 2000 to 2200 (Hv 20), transverse rupture strength of 500 to 800 MPa, Young's modulus of 380 to 410 GPa, coefficient of thermal conductivity of 22 to 33 W/mK, and coefficient of thermal expansion of 7.0×10⁻⁶ to 7.3×10⁻⁶ [1/° C.], so as to be favorable as a flat panel display spacer material from any of viewpoints such as strength.

Within the composition range of the sintered body in accordance with this embodiment, the resistivity value varies only about 1×10² times or less when the TiC composition fluctuates by about 1 wt %, and when the TiO₂ composition fluctuates by about 0.5 wt %, for example. Therefore, even when errors in manufacture and the like occur in the compositions of TiO₂ and TiC, the fluctuation in the resistivity value of the manufactured spacer base material is relatively small. Consequently, a spacer base material having a resistivity value on the order of 1×10⁶ to 1×10¹¹ Ω.cm can easily be obtained with a high yield.

The outline of a flat panel display spacer formed from the above-mentioned spacer base material and an FED which is a flat panel display employing this spacer will now be explained.

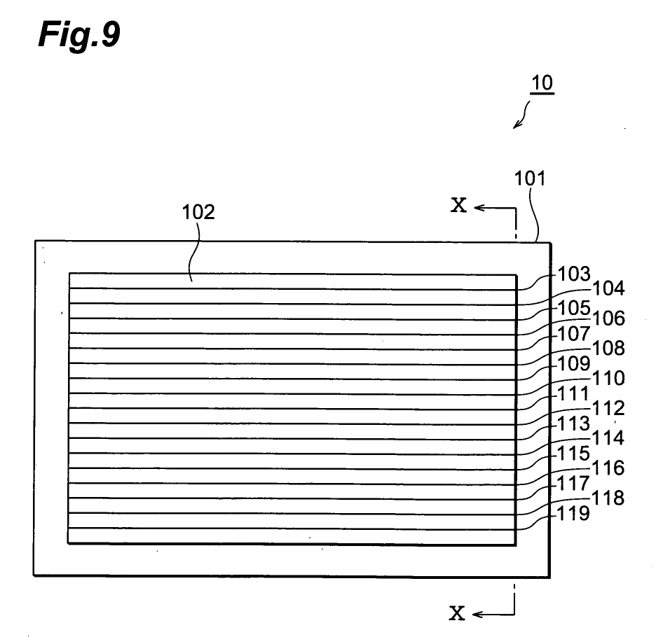

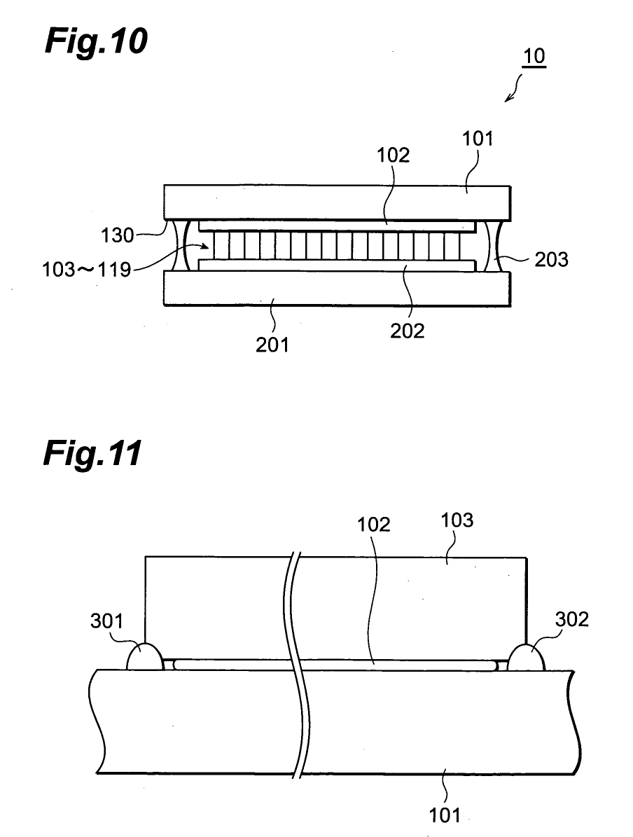

FIG. 9 is a plan view of the flat panel display 10. FIG. 10 is a sectional view of the flat panel display 10 taken along the line X-X. FIG. 11 is a side view of the flat panel display showing the inner structure thereof on the faceplate side.

A black matrix structure 102 is formed on a faceplate 101 made of glass. The black matrix structure 102 includes a plurality of fluorescent pixel areas each made of a phosphorus layer. When a high energy electron impinges on the phosphorus layer, the latter emits light, thereby forming a visible display. The light emitted from a specific fluorescent pixel area is outputted to the outside by way of the black matrix structure. The black matrix is a grid-like black structure for restraining light beams from fluorescent pixel areas adjacent to each other from mingling.

Attached onto the faceplate 101 are spacers 103 to 119 which are walls erect from its surface.

By way of the spacers 103 to 119 (103, 104, 105, 106, 107, 108, 109, 110, 111, 112, 113, 114, 115, 116, 117, 118, 119), a backplate 201 is disposed on the faceplate 101 (see FIG. 10). The spacers 103 to 119 evenly keep the gap between the faceplate 101 and backplate 201. The active area surface of the backplate 201 includes a cathode structure 202. The cathode structure 202 includes a plurality of cathodes (electric field (electron) emission devices) made of projections for emitting electrons.

The region formed with the cathode structure 202 is smaller than the area of the backplate 201. A glass seal 203 is interposed between the outer peripheral region of the faceplate 101 and the outer peripheral region of the backplate 201, thus providing a closed chamber at the center part. The closed chamber is vacuumed to such an extent that electrons can fly therein. The cathode structure 202, black matrix structure 102, and spacers 103 to 119 are arranged in the closed chamber. The seal 203 is formed from molten glass frit.

Since all the spacers 103 to 119 have the same structure, the following explanation will be focused on one spacer 103.

As shown in FIG. 11, the spacer (flat panel display spacer) 103 is secured to the faceplate 101 by adhesives 301, 302 provided at both longitudinal ends of the spacer. Though the material of the adhesives 301, 302 in this example is a UV-curable polyimide adhesive, a thermosetting adhesive or inorganic adhesive can be used. The adhesives 301, 302 are disposed on the outside of the black matrix structure 102.

The spacer 103 will now be explained in detail.

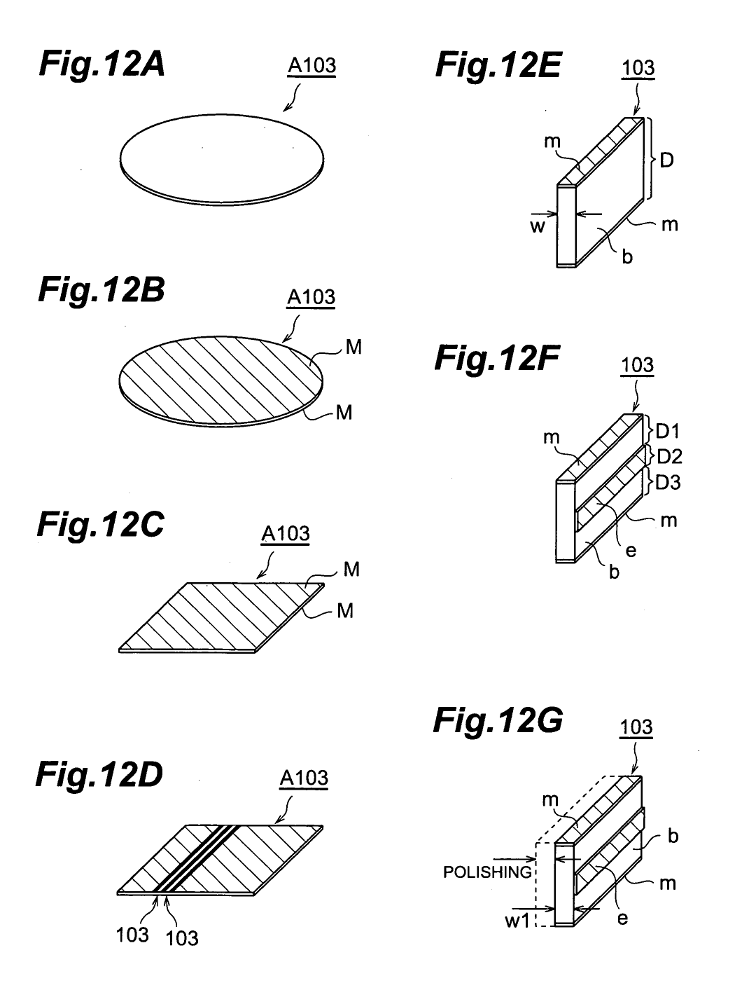

FIGS. 12A to 12G are explanatory views for explaining an example of methods of manufacturing the spacer 103. This spacer manufacturing method is a method of manufacturing the above-mentioned flat panel display spacer interposed between the backplate (201) including the cathode structure (202) and the faceplate (101) including the fluorescent pixel area (black matrix structure 102). The spacer 103 can be manufactured by successively carrying out the following steps (1) to (7), for example.

(1) A substrate of the above-mentioned composite ceramic sintered body (flat panel display spacer base material) A103 is prepared (FIG. 12A).

(2) Subsequently, metal films M each made of a metal such as Ti, Au, Cr, or Pt having a thickness of several nanometers to 1 μm are formed on both sides of the substrate A103 by sputtering (FIG. 12B). The metal films M will be referred to as metal films m after being cut.

(3) Peripheries of the substrate A103 are cut and removed so that the remainder attains a quadrangular form (FIG. 12C).

(4) The substrate A103 is cut at intervals (W) each smaller than the thickness (D) of the substrate into strips, which are separated from each other and then washed (FIG. 12D).

(5) All the cut sections of the cut strips are simultaneously polished such that the size W of each strip in a direction perpendicular to the cut sections becomes 300±50 μm (FIG. 12E).

(6) A metal film e is formed by patterning on an end face parallel to a plane including the thickness and longitudinal directions of the spacer 103 (FIG. 12F). For forming this, the end face is washed first. Subsequently, a metal film made of Ti, Au, Cr, Pt, or the like is deposited by sputtering on the end face by 100 nm, a mask for dry etching is patterned on the metal film, and then the metal film is etched by ion milling, so as to form the metal film e. The longitudinal direction of the metal film e coincides with that of the spacer 103.

In the thickness direction D, the distance D1 from one end part of the spacer 103 to the metal film e, the size D2 of the metal film e, and the distance D3 from the other end part of the spacer 103 to the metal film e are set such that their product tolerances and errors fall within ±50 μm.

(7) The end faces of a plurality of strips on the side opposite from the end face mentioned above are polished simultaneously, so as to set the width W1 of each strip to a value selected from 50 to 100 μm (FIG. 12G). As this value is smaller, the spacer 103 is less visible but harder to endure compressive forces. Therefore, the value is selected from 50 to 100 μm in this example. The above-mentioned polishing encompasses mechanical polishing and/or chemical polishing.

In each step, the flatness is suppressed to 50 μm or less.

The spacer 103 contains the above-mentioned sintered body, i.e., a composite ceramic sintered body containing Al₂O₃, TiC, and TiO₂ such that at least 6.5 wt % but not greater than 10 wt % of TiC and at least 1.0 wt % but not greater than 2.5 wt % of TiO₂ exist when the total weight of Al₂O₃, TiC, and TiO₂ is assumed to be 100 wt %. Therefore, as mentioned above, the spacer can endure deformations due to compressive forces, and exhibit a desirable conductivity even upon electric field application, so that electric charges and thermal runaway are harder to occur, whereby image distortions and the like can effectively be suppressed.

This spacer 103 has the metal films m on both end faces in the thickness direction thereof. The metal films m are part of the metal films M formed before the cutting. The metal films m reduce the in-plane unevenness of contact resistance and the like between the backplate and faceplate, thereby contributing to setting the resistivity and conductivity in the whole spacer.

The above-mentioned spacer 103 is a rectangular parallelepiped having an end face parallel to a plane including the thickness and longitudinal directions, whereas the patterned metal film e is provided on this end face. While this pattern defines an internal electric field distribution, the accuracy in its forming position along the thickness of the substrate can be made higher than that in the case formed on the original substrate surface, since the accuracy in the thickness direction is higher.

The above-mentioned spacer can also be employed in reflection type FEDs. The above-mentioned spacer base material may contain other materials to such an extent that characteristics are not greatly influenced thereby.

### INDUSTRIAL APPLICABILITY

As mentioned above, the present invention provides a flat panel display spacer base material, a method of manufacturing the same, a flat panel display spacer, and a flat panel display which can further reduce the occurrence of image distortions and the like.

1. A flat panel display spacer base material including a sintered body containing Al₂O₃, TiC, and TiO₂ such that 6.5 to 10 wt % of TiC and 1.0 to 2.5 wt % of TiO₂ exist with respect to the total weight of Al₂O₃, TiC, and TiO₂.

2. A method of manufacturing a flat panel display base material comprising the steps of:
mixing powders of Al₂O₃, TiC, and TiO₂ such that 6.5 to 10 wt % of the TiC powder and 1.0 to 2.5 wt % of the TiO₂ powder exist with respect to the total weight of Al₂O₃, TiC, and TiO₂ powders; and
firing thus obtained mixture so as to yield a sintered body.

3. A flat panel display spacer formed from a sintered body containing Al₂O₃, TiC, and TiO₂ such that 6.5 to 10 wt % of TiC and 1.0 to 2.5 wt % of TiO₂ exist with respect to the total weight of Al₂O₃, TiC, and TiO₂, the flat panel display spacer being interposed between a backplate including a cathode structure and a faceplate including a fluorescent pixel area.

4. A flat panel display comprising:
a backplate including a cathode structure;
a faceplate including a fluorescent pixel area; and
a flat panel display spacer interposed between the backplate and the faceplate and formed from a sintered body containing Al₂O₃, TiC, and TiO₂ such that 6.5 to 10 wt % of TiC and 1.0 to 2.5 wt % of TiO₂ exist with respect to the total weight of AL₂o₃, TiC, and TiO₂.
